(19) United States
(12) Patent Application Publication
(10) Pub. No.: US 2013/0310053 A1
(43) Pub. Date: Nov. 21, 2013

(54) CREATING GEOFENCE ASSISTANCE INFORMATION

(71) Applicants: Aditya N. Srivastava, Fremont, CA (US); Suhas H. Sheshadri, San Jose, CA (US)

(72) Inventors: Aditya N. Srivastava, Fremont, CA (US); Suhas H. Sheshadri, San Jose, CA (US)

(73) Assignee: QUALCOMM ATHEROS, Incorporated, San Jose, CA (US)

(21) Appl. No.: 13/472,342

(22) Filed: May 15, 2012

(51) Int. Cl. H04W 16/24; H04W 4/02; H04W 24/00

(52) U.S. Cl. 455/446

(57) ABSTRACT

Example methods, apparatuses, or articles of manufacture are disclosed herein that may be utilized, in whole or in part, to facilitate or support one or more operations or techniques for creating geofence assistance information, such as for use in or with a mobile communication device. Briefly, in accordance with at least one implementation, a method may include determining a geofence boundary; and identifying transmission cells forming a loop of contiguous cell coverage areas approximating the geofence boundary. In some instances, a loop of contiguous cell coverage areas approximating a geofence boundary may comprise a loop of contiguous cell coverage areas approximating a perimeter of the geofence boundary, for example.

### BACKGROUND

1. Field

The present disclosure relates generally to position or location estimations of mobile communication devices and, more particularly, to creating geofence assistance information for use in or with mobile communication devices.

2. Information

Mobile communication devices, such as, for example, cellular telephones, personal digital assistants, electronic book readers, portable navigation units, laptop computers, or the like are becoming more common every day. As geographic barriers to personal travel decrease, mobile communication devices play a role in allowing society to maintain its mobility. Continued advancements in information technology, communications, mobile applications, or the like help to contribute to a rapidly growing market for mobile communication devices, which have become ubiquitous and may already be viewed as “extensions of the hand” altering the manner in which society communicates, does business, or creates value.

Certain mobile communication devices may, for example, feature a location-aware or location-tracking capability to assist users in estimating their geographic locations by providing position information obtained or gathered from various systems. For example, a mobile communication device may obtain a location estimate or so-called “position fix” by acquiring wireless signals from a satellite positioning system (SPS), such as the global positioning system (GPS) or other like Global Navigation Satellite System (GNSS), cellular base station, location beacon, or the like via a cellular telephone or other wireless communications network. Received wireless signals may, for example, be processed by or at a mobile communication device, and its location may be estimated using appropriate techniques, such as, for example, Advanced Forward Link Trilateration (AFLT), base station identification, or the like.

In some instances, certain location-aware mobile communication devices may employ a so-called “geofence” bounding a region of interest so as to detect entries into or exits from the region in conjunction with a position fix obtained via a suitable positioning technique. A geofence may comprise a virtual perimeter on a geographic area established in connection with a suitable location-based service (LBS), for example, such that if a tracked mobile communication device enters or exits the area a notification is generated. A notification may be provided via an e-mail, text message, etc. and may comprise, for example, information about a location of a tracked mobile communication device, time of crossing a geofence boundary or geofence breach, whether the device is inside or outside a geofence, or the like. At times, detection of a geofence breach may, for example, involve monitoring or tracking a position of a mobile communication device in a substantially continuous fashion. This, however, may increase power consumption of certain devices, such as mobile communication devices with limited power resources, for example, thus, affecting operating lifetime or overall utility of such devices.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating features associated with an implementation of an example operating environment.

FIG. 2 is a flow diagram illustrating a summary of an implementation of an example process for creating geofence assistance information.

FIG. 3 is a schematic illustration of an implementation of an example loop of contiguous cell coverage areas surrounding a geofence boundary.

FIG. 4 is a schematic illustration of an implementation of an example zooming out of a scan area.

FIG. 5 is a flow diagram illustrating an implementation of an example process for creating geofence assistance information.

FIG. 6 is a schematic diagram illustrating an implementation of an example computing environment associated with a mobile device.

FIG. 7 is a schematic diagram illustrating an implementation of an example computing environment associated with a server.

### SUMMARY

Example implementations relate to creating geofence assistance information for use in or with a mobile communication device. In one implementation, a method may comprise determining a geofence boundary; and identifying transmission cells forming a loop of contiguous cell coverage areas approximating the geofence boundary.

In another implementation, an apparatus may comprise one or more processors programmed with instructions to determine a geofence boundary; and identify transmission cells forming a loop of contiguous cell coverage areas approximating the geofence boundary.

In yet another implementation, an apparatus may comprise means for determining a geofence boundary; and means for identifying transmission cells forming a loop of contiguous cell coverage areas approximating the geofence boundary.

In yet another implementation, an article may comprise a non-transitory storage medium having instructions stored thereon executable by a special purpose computing platform to determine a geofence boundary; and identify transmission cells forming a loop of contiguous cell coverage areas approximating the geofence boundary. It should be understood, however, that these are merely example implementations, and that claimed subject matter is not limited to these particular implementations.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, or articles of manufacture are disclosed herein that may be implemented, in whole or in part, to facilitate or support one or more operations or techniques for creating geofence assistance information for use in or with a mobile communication device. As used herein, “mobile device,” “tracked mobile device,” “mobile communication device,” “wireless device,” “location-aware mobile device,” or the plural form of such terms may be used interchangeably and may refer to any kind of special purpose computing platform or apparatus that may from time to time have a position or location that changes. In some instances, a mobile communication device may, for example, be capable of communicating with other devices, mobile or otherwise, through wireless transmission or receipt of information according to one or more communication protocols. As a way of illustration, special purpose mobile communication devices, which may herein be called simply mobile devices, may include, for example, cellular telephones, smart telephones, personal digital assistants (PDAs), laptop computers, personal entertainment systems, tablet personal computers (PC), personal audio or video devices, personal navigation devices, or the like. It should be appreciated, however, that these are merely examples of mobile devices that may be used, at least in part, to implement one or more operations or processes for creating geofence assistance information, and that claimed subject matter is not limited in this regard. It should also be noted that the terms “position” and “location” may be used interchangeably herein.

As previously mentioned, in some instances, a location-tracking or like application hosted on a mobile device may employ a geofence bounding a region of interest to detect an entry into or exit from such a region, for example, in conjunction with a position fix obtained via a suitable positioning technique. Typically, although not necessarily, a geofence may be employed in connection with a suitable LBS to determine whether a tracked mobile device, such as carried by a truck, car, person, etc. has crossed or breached a geofence boundary, such as from the inside or outside. At times, to determine whether a geofence boundary has been crossed or breached in a timely fashion, relatively frequent position fixes, such as using GPS or like GNSS may, for example, be needed or otherwise useful. For example, for a relatively accurate geofence breach determination, a mobile device may continually search for or monitor wireless signals from a GNSS to facilitate or support tracking of the device in a substantially continuous fashion. As used herein, “monitoring” may refer to detecting, receiving, or otherwise acquiring at least one wireless signal in such a manner so as to allow for a signal presence, strength, or other characteristic to be obtained or measured.

Obtaining relatively frequent position fixes, however, may increase power consumption of certain devices, such as mobile devices having limited power resources (e.g., battery-operated, etc.), for example, and may negatively impact their operating lifetime, overall utility, or the like. In some instances, increasing a time interval between position fixes (e.g., via a fixed schedule, etc.) may partially help with or otherwise improve power consumption, but may affect in some manner other geofence-related parameters, such as geofence sensitivity or geofence accuracy, for example. For purposes of explanation, geofence sensitivity may, for example, characterize or describe how fast a mobile device may detect or recognize that it has entered or exited a bounded area defined by a geofence. Geofence accuracy may, for example, characterize or describe how accurate detection is of an entering or exiting event for a geofence. Thus, geofence power consumption may characterize or describe, for example, the amount of power consumed by a tracked mobile device for a given geofence sensitivity and accuracy. Of course, these are merely examples of parameters that may be used or otherwise considered in connection with geofence breach detection, and claimed subject matter is not so limited.

Faster or more accurate geofence breach detection may facilitate or support a better or more satisfying user experience, for example, and may lead to increased usability of a geofence, associated service, applicable technology, mobile device, or the like. However, in certain simulations or experiments, it has been observed that the higher geofence sensitivity or accuracy, for example, the higher geofence power consumption. Claimed subject matter is not limited to such an observation, of course. In some instances, a higher rate of power consumption may at least partially be attributed to a continual tracking or monitoring of a mobile device, such as to obtain relatively frequent position fixes, for example, as alluded to previously. Yet, for a geofence established or implemented in one geographic area (e.g., California, etc.), relatively frequent position fixes, such as for geofence breach detection, for example, may not be needed or otherwise useful if a tracked mobile device is in another geographic area (e.g., Florida, etc.). In other words, at times, initiating relatively frequent position fixes to determine a location of a mobile device, such as relative to a geofence of interest, for example, may not be needed or otherwise useful unless or until the mobile device is within a sufficiently close proximity to the geofence. Accordingly, it may be desirable to develop one or more methods, systems, or apparatuses that may implement more effective or efficient geofence breach detection, which may reduce power consumption of a tracked mobile device, for example, for a given geofence sensitivity or accuracy.

As will be described in greater detail below, in an implementation, to facilitate or support more effective or efficient geofence breach detection, suitable geofence assistance information may, for example, be created or provided for use by a mobile device, applicable server, or any combination thereof. In some instances, assistance information may comprise, for example, a cell identification (Cell-ID) list identifying a number of transmission cells associated with a cellular or like wireless communications network of a tracked mobile device and forming a loop of contiguous cell coverage areas approximating a geofence boundary. For purposes of explanation, typically, although not necessarily, a functional or active transmission cell transmits a unique pilot signal allowing a mobile device to identify the cell based, at least in part, on a unique identification number or so-called “Cell-ID”, such as at or upon acquisition of the signal, for example. Thus, if a mobile device acquires a pilot signal or otherwise recovers a Cell-ID, the mobile device may, for example, determine that it is located in a coverage area of the cell. As will be seen, in some instances, a breach of a geofence boundary may, for example, be determined as being imminent or otherwise likely if a mobile device detects that it is in a coverage area of a transmission cell (e.g., identified via a Cell-ID, etc.) in a loop of contiguous cell coverage areas. Having determined that a geofence breach is imminent or otherwise likely, a mobile device may, for example, power up an SPS receiver or like positioning unit and may initiate a position fix.

In at least one implementation, a suitable scan area, such as a geographic area enclosing a geofence boundary, for example, may be formed. Within a formed scan area, a set of suitable transmission cells, such as cells with coverage areas not intersecting with a geofence boundary, for example, may be determined. Based, at least in part, on suitable transmission cells, a loop of contiguous cell coverage areas approximating a geofence boundary may, for example, be identified. A list of Cell-IDs associated with transmission cells forming a loop may, for example, be generated, such as by a suitable server, mobile device, etc., and may be provided for use as geofence assistance information. In some instances, a position fix may, for example, be advantageously postponed or deferred until a mobile device “camps” on or detects that it is in a coverage area of a transmission cell in a loop of transmission cells, such as identified via a Cell-ID list. As such, by approximating a geofence boundary, a continual tracking or monitoring of a mobile device may not be needed or otherwise useful unless or until, for example, the mobile device is within a sufficiently close proximity to the geofence. This may reduce or otherwise improve power consumption of a tracked mobile device, such as for a given geofence sensitivity or accuracy, for example, as previously mentioned.

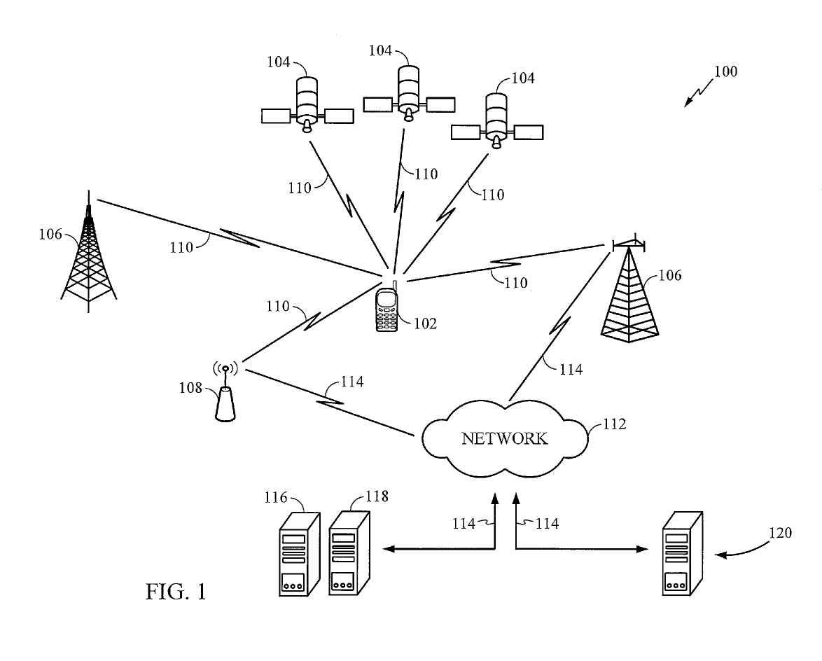

FIG. 1 is a schematic diagram illustrating features associated with an implementation of an example operating environment 100 capable of facilitating or supporting one or more processes or operations for creating geofence assistance information that may be used, at least in part, by a suitable device, such as a mobile device 102, for example. It should be appreciated that operating environment 100 is described herein as a non-limiting example that may be implemented, in whole or in part, in the context of various communications networks or combination of networks, such as public networks (e.g., the Internet, the World Wide Web), private networks (e.g., intranets), wireless local area networks (WLAN), wireless wide area networks (WWAN), mobile ad-hoc networks (MANET), wireless mesh networks (WMN), wireless sensor networks (WSN), wireless personal area network (WPAN), or the like. Operating environment 100 may, for example, be communicatively enabled using one or more special purpose computing platforms, communication devices, information storage devices, databases, computer-readable codes or instructions, e-mail or text messaging information, specific applications or functionalities, various electrical or electronic circuitry or components, etc., as described herein with reference to one or more example implementations.

As illustrated, operating environment 100 may comprise, for example, one or more satellites 104, base transceiver stations 106, wireless transmitters 108, etc. capable of communicating with mobile device 102 via wireless communication links 110 in accordance with one or more communication protocols. Satellites 104 may be associated with one or more satellite positioning systems (SPS), such as, for example, the United States Global Positioning System (GPS), the Russian GLONASS system, the European Galileo system, as well as any system that may utilize satellites from a combination of satellite systems, or any satellite system developed in the future. Base transceiver stations 106, wireless transmitters 108, etc. may be of the same or similar type, for example, or may represent different types of devices, such as access points, radio beacons, cellular base stations, femtocells, or the like, depending on an implementation. At times, one or more wireless transmitters, such as wireless transmitters 108, for example, may be capable of transmitting as well as receiving wireless signals.

In some instances, one or more base transceiver stations 106, wireless transmitters 108, etc. may, for example, be operatively coupled to a network 112 that may comprise one or more wired or wireless communications or computing networks or resources capable of providing suitable information, such as via one or more communication links 114. Information may include, for example, one or more geofence-related parameters (e.g., a location, boundary, etc. of a geofence), estimated location (e.g., a position fix, etc.) with respect to mobile device 102, one or more base transceiver stations 106, wireless transmitters 108, etc., though claimed subject matter is not so limited. At times, geofence assistance information may include a Cell-ID list identifying a number of transmission cells, such as, for example, one or more base transceiver stations 106, wireless transmitters 108, or the like forming a loop of contiguous cell coverage areas approximating a suitable geofence boundary, as will be seen.

In an implementation, network 112 may be capable of facilitating or supporting communications between or among suitable computing platforms or devices, such as, for example, mobile device 102, one or more satellites 104, base transceiver stations 106, wireless transmitters 108, etc., as well as one or more servers associated with operating environment 100. In some instances, servers may include, for example, a location server 116, geofence assistance server 118, as well as one or more other servers, indicated generally at 120 (e.g., navigation, information, map, etc. server), capable of facilitating or supporting one or more operations or processes associated with operating environment 100. Location server 116 may, for example, provide a position fix with respect to mobile device 102, such as by acquiring wireless signals from satellites 104, base transceiver stations 106, wireless transmitters 108, etc. using one or more appropriate techniques (e.g., AFLT, AGPS, etc.). Geofence assistance server 118 may be used, at least in part, to obtain suitable geofence assistance information (e.g., a Cell-ID list, etc.), such as in connection with a geofence breach detection, for example. Server 120 may, for example, provide suitable geofence-related information (e.g., a digital map applicable to a geofence, etc.), such as via one or more computing resources associated with network 112.

It should be appreciated that even though a certain number or type of computing platforms or devices are illustrated herein, any number or type of computing platforms or devices may be implemented herein to facilitate or support one or more techniques or processes associated with operating environment 100. At times, network 112 may, for example, be coupled to one or more other wired or wireless communications networks (e.g., Wi-Fi, WLAN, WWAN, etc.) so as to enhance a coverage area for communications with mobile device 102, one or more base transceiver stations 106, wireless transmitters 108, applicable servers, or the like. For example, in some instances, network 112 may facilitate or support femtocell-based or like operative regions of coverage, just to illustrate one possible implementation. Again, operating environment 100 is merely an example, and claimed subject matter is not limited in this regard.

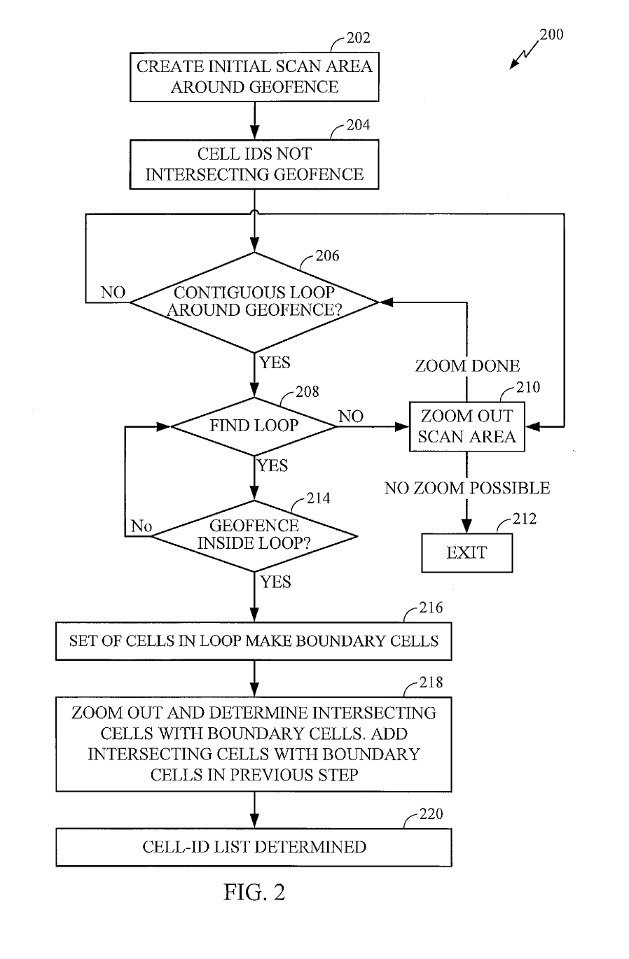

With this in mind, attention is now drawn to FIG. 2, which is a flow diagram illustrating a summary of an implementation of an example process 200 that may be performed, in whole or in part, to facilitate or support creating geofence assistance information that may be provided for use by a mobile device, such as to detect a breach of a geofence boundary from the outside, for example. It should be noted that information acquired or produced, such as, for example, input signals, output signals, operations, results, etc. associated with example process 200 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

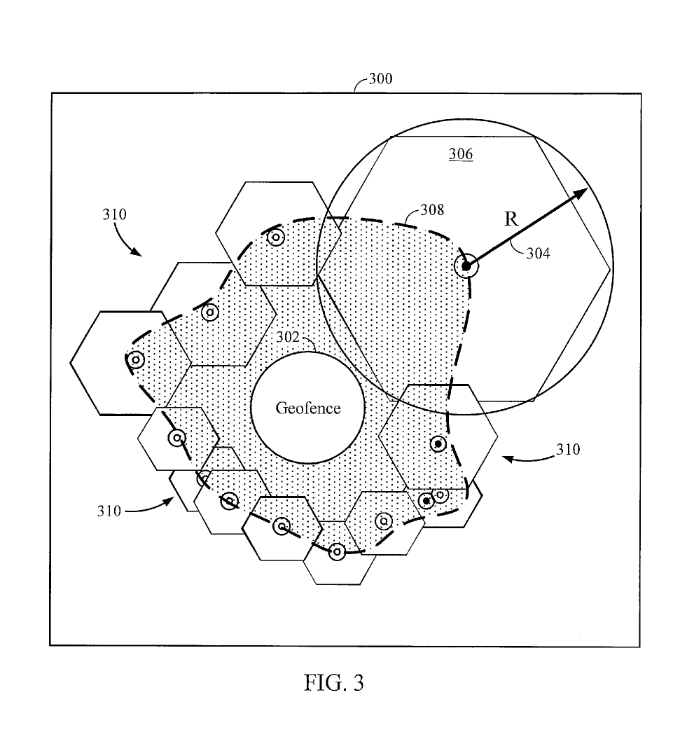

Example process 200 may, for example, begin at operation 202 with creating an initial scan area around a geofence of interest. It should be noted that a scan area may comprise any suitable shape or size. For example, as illustrated in FIG. 3, in one implementation, a scan area may comprise a scan box 300, such as formed around a geofence boundary 302, though claimed subject matter is not so limited. A size or shape of a scan area may be determined experimentally and may be pre-defined or configured, for example, or otherwise dynamically defined in some manner, depending on an application, geofence, transmission cells, LBS, or the like. By way of example but not limitation, in one particular simulation or experiment, it appeared that treating or otherwise considering one or more transmissions cells as having circular-type coverage may prove beneficial for determining a size or shape of a scan area in particular or creating geofence assistance information in general. Thus, in some instances, it may be assumed that a radius R, referenced generally at 304, of a suitable transmission cell, such as a cell 306, for example, may be relatively equivalent to or otherwise comprise a Maximum Antenna Range (MAR) of the cell. As such, at times, a size of a scan area, such as scan box 300, for example, may be determined, at least in part, in relation to a MAR of one or more suitable transmission cells. As a way of illustration, in at least one implementation, a factor of two or more relative to a MAR of a large or otherwise suitable transmission cell (e.g., two-times MAR in all directions, etc.) may be used. Of course, details relating to creating an initial scan area are intended as merely examples to which claimed subject matter is not limited. For example, in some instances, a scan area may be created by defining any arbitrary area around a geofence.

Referring back to process 200 of FIG. 2, at operation 204, a set of Cell-IDs of transmission cell coverage areas that are not intersecting with a geofence of interest may be determined, such as within a created scan area, for example. Having cells not intersecting with a geofence boundary may, for example, facilitate or support geofence accuracy or sensitivity, among other aspects, such as by allowing a mobile device to timely initiate a position fix (e.g., before crossing a geofence boundary, etc.). With regard to operation 206, it may be determined whether a loop of contiguous cell coverage areas surrounding a geofence boundary of interest exists. For example, it may be determined that a loop of contiguous cell coverage areas exists if there are no gaps in coverage areas between adjacent transmission cells in a set of Cell-IDs. As particularly seen in FIG. 3, a loop of contiguous cell coverage areas, schematically illustrated via a dashed line at 308, may comprise, for example, a plurality of transmission cells 310 having common or overlapping coverage areas and surrounding a boundary of geofence 302. It should be noted that even though loop 308 is schematically illustrated as passing through or looping via centers of transmission cells 310, loop 308 may, for example, be defined via any suitable points within cell coverage areas of interest, such as points where transmission cells connect, converge, overlap, or the like, if desired.

As further illustrated in FIG. 2, at operation 208, process 200 may, for example, proceed to find or identify a loop of contiguous cell coverage areas surrounding a geofence boundary of interest (e.g., geofence boundary 302 of FIG. 3, etc.), such as within a scan area. If no loop may be found or identified, a scan area may, for example, be expanded or zoomed out incrementally, as referenced at operation 210, until a loop of contiguous cell coverage areas within the scan area may be found or identified. For example, in some instances, a magnification of a scan area may be incrementally decreased (e.g., digitally, at a geofence level, etc.), such that a larger number of transmission cells may appear within or be covered by the scan area, just to illustrate one possible implementation.

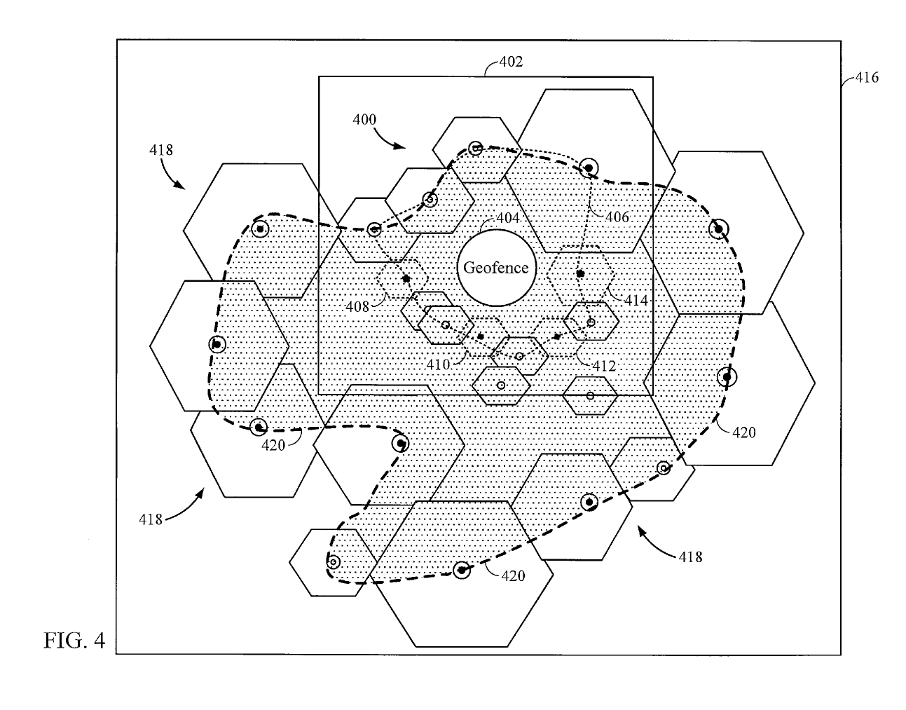

Turning now to FIG. 4, a schematic illustration of an implementation of an example expansion or zooming out of a scan area of interest is shown. As seen, certain transmission cells, such as cells 400 identified within an initial scan box 402, for example, do not form a loop of contiguous cell coverage areas surrounding a geofence 404. For example, as schematically illustrated via a dotted line at 406, here, a loop of cell coverage areas surrounding geofence 404 is rather not contiguous since a number of associated transmission cells, such as cells 408, 410, 412, and 414 referenced via dotted lines, are missing. At times, cells may be or otherwise considered missing if, for example, some cell-related terrestrial or like information (e.g., a location of a cell, Cell-ID, MAR, etc.) is unavailable or otherwise incomplete. Accordingly, a scan area may be expanded or zoomed out, as illustrated via a scan box 416, such as to cover a relatively larger geographic area comprising, for example, a larger number of transmission cells, referenced generally at 418. Again, here, it may be determined, for example, whether a loop of contiguous cell coverage areas surrounding geofence 404 within scan box 416 exists (e.g., via operations 206, 208, etc. of FIG. 2). For this example, it appears that a suitable loop exists, as schematically illustrated via a dashed line at 420, since coverage areas of transmission cells 418 surrounding geofence 404 are contiguous, as discussed above (e.g., no gaps between coverage areas of adjacent cells, etc.).

Although not shown, it should be noted that in some instances more than one loop of contiguous cell coverage areas surrounding geofence 404 may, for example, be determined or identified, such as within initial scan box 402, 416, etc. For example, a suitable process (e.g., process 200 of FIG. 2, etc.) may repeat one or more operations (e.g., operations 206, 208, 210, etc. of FIG. 2) so as to facilitate or support determination of one or more possible loops within a scan area of interest. If more than one loop of contiguous cell coverage areas surrounding geofence 404 is identified, a loop more closely approximating a geofence boundary may, for example, be selected. For example, from a plurality of loops, a loop of contiguous cell coverage areas approximating a perimeter of a boundary of geofence 404 may be selected, just to illustrate one possible implementation. In this context, “approximating” may refer to a relatively close representation or modeling of an object's (e.g., a geofence boundary, etc.) length, form, shape, area, or the like, such as for use in a particular application. For example, in some instances, the smallest loop fully surrounding geofence 404, such as within initial scan box 402, 416, etc., may be selected as approximating a perimeter of a boundary of geofence 404. Of course, these are merely details relating to approximating a geofence boundary, and claimed subject matter is not so limited.

Continuing with FIG. 2, as seen, example process 200 may repeat one or more functions associated with operation 210, such as zooming out of a scan area of interest, for example, as referenced via an applicable return path from operations 206 or 208. If no zooming out of a scan area is possible or feasible (e.g., an allowable focal length, magnification, etc. has been reached, etc.), however, process 200 may be terminated, such as at operation 212. Alternatively, having found or identified a suitable loop of contiguous cell coverage areas, such as within a scan area, at operation 214, it may be determined whether a geofence of interest (e.g., geofence 404 of FIG. 4, etc.) is inside the loop. For example, in some instances, it may be determined that a geofence is inside a loop if the geofence is completely surrounded by coverage areas of associated transmission cells, such that no part of the geofence intersects with a path of the loop (e.g., 208 of FIG. 3, 406 or 420 of FIG. 4, etc.). If it is determined that a geofence is not inside a loop, example process 200 may return to operation 208, such as to find or identify another loop of contiguous cell coverage areas surrounding a geofence boundary of interest, for example. Again, here, if suitable, one or more zooming out or associated operations may, for example, be performed, as discussed above. If yes, on the other hand, process 200 may, for example, continue to operation 216 to identify a set of transmission cells in a suitable loop of contiguous cell coverage areas. Here, a set of identified transmission cells may, for example, comprise or define an initial list of boundary cells surrounding a geofence of interest.

With regard to operation 218, a scan area of interest may be further zoomed out in a suitable manner, such as employing or otherwise considering a MAR of one or more suitable transmission cells, for example, as was indicated. Here, one or more transmission cells having coverage areas intersecting, overlapping, etc. with a set of boundary cells on an initial list discussed above, may, for example, be identified or determined. Having one or more additional cells may facilitate or support geofence breach detection, such as, for example, by ensuring that a tracked mobile device will not “squeeze in” or pass unnoticed inside a geofence boundary without “camping” on at least one transmission cell associated with boundary cells. Thus, once identified, one or more intersecting, overlapping, etc. transmission cells may be added to or included into an initial list of boundary cells to comprise, for example, a Cell-ID list, as referenced at operation 220. A cell-ID list may, for example, be saved in memory of any suitable device, such as a mobile device, applicable server (e.g., geofence assistance server 118 of FIG. 1, etc.), or any combination thereof, as or as part of geofence assistance information.

Thus, as illustrated, geofence assistance information comprising, for example, transmission cells forming a loop of contiguous cell coverage areas surrounding a geofence boundary may be identified, such as via an iterative-type process or procedure. A similar approach may, for example, be utilized, at least in part, to facilitate or support creating geofence assistance information to detect a breach of a geofence boundary from the inside (e.g., at or upon exiting a geofence, etc.). To illustrate, in an implementation, a suitable scan area may be formed, such as completely within a geofence boundary, for example, and a set of Cell-IDs not intersecting with a geofence boundary may be identified. Likewise, here, a scan area may be created, such as by forming a scan box sufficiently or otherwise suitably close to a geofence boundary, for example, so as to facilitate or support approximating its perimeter, though claimed subject matter is not so limited. Within a scan box, a determination may, for example, be made whether a loop of contiguous cell coverage areas exists, such as using one or more techniques discussed above (e.g., via identifying missing cells, coverage gaps, etc.).

In some instances, if there is no suitable loop, a scan area may, for example, be zoomed in, such as by incrementally increasing the magnification of the scan area until transmission cells forming one or more possible loops of contiguous cell coverage areas approximating a geofence boundary may be identified. Optionally or alternatively, a scan area may be zoomed out, such as to also identify one or more possible loops within a scan area, for example, or if an initial scan area was defined relatively arbitrarily (e.g., without a MAR, further away from a boundary, etc.), or the like. Here, one or more transmission cells having coverage areas intersecting, overlapping, etc. with boundary cells associated with a suitable loop may be identified, such as via one or more zooming in or zooming out operations, for example, and added to boundary cells. Thus, here, similarly, a Cell-ID list identifying transmission cells forming a loop of contiguous cell coverage areas approximating a geofence boundary may, for example, be generated or used, at least in part, as geofence assistance information. Of course, these are merely details relating to creating geofence assistance information for geofence breach detection from the inside, and claimed subject matter is not so limited.

As alluded to previously, it should be appreciated that geofence assistance information may, for example, be created or stored by or at a mobile device, suitable server (e.g., geofence assistance server 118 of FIG. 1, etc.), or any combination thereof. It should also be noted that one or more operations or techniques discussed herein may be applied to any suitable wireless or like radio technology, such as, for example, Wi-Fi access point-type coverage maps, Bluetooth® communication-related coverage areas, ZigBee® or like wireless mesh-type coverage areas, or the like to create suitable geofence or like assistance information without deviating from the scope of claimed subject matter. Thus, one or more operations or techniques discussed herein may be utilized, in whole or in part, in connection with transmission cells comprising, for example, a base transceiver station or like wireless transmitter associated with a cellular or like wireless communications network, such as an access point, a femtocell, a wireless transmission node, such as a Bluetooth® or ZigBeee®-type network node (e.g., full-function, reduced function, etc.), or the like, or any combination thereof. Of course, these are merely examples of transmission cells that may be employed herein, and claimed subject matter is not limited in this regard.

In some instances, it may be assumed that terrestrial or like (e.g., WWAN, etc.) transmission cell-related information (e.g., a location of a cell, Cell-ID, MAR, etc.) used, in whole or in part, to create geofence assistance information may, for example, be obtained using any one of several appropriate techniques, proprietary (e.g., Qualcomm®'s XTRA-T, etc.) or otherwise. For example, at times, terrestrial or like transmission cell-related information may be gathered or collected, at least in part, via crowd-sourcing, though claimed subject matter is not so limited. To illustrate, one or more mobile devices associated with traveling users may communicate to a suitable server information indicative of a network topology, such as identities, locations, etc. of encountered or observed transmission cells, for example, at or upon acquisition of a respective pilot or like signal. Communicated information may be stored in some manner, such as in a suitable database (e.g., geofence assistance database, etc.) as, for example, an almanac descriptive of an associated cellular network topology, just to illustrate one possible implementation. An almanac or database may, for example, be subsequently queried, such as by a mobile device, suitable server, etc. so as to facilitate or support one or more operations or processes for creating geofence assistance information, as discussed above. Optionally or alternatively, terrestrial or like transmission cell-related information may be collected or stored on a mobile device, for example, to facilitate or support creating geofence assistance information on a mobile device.

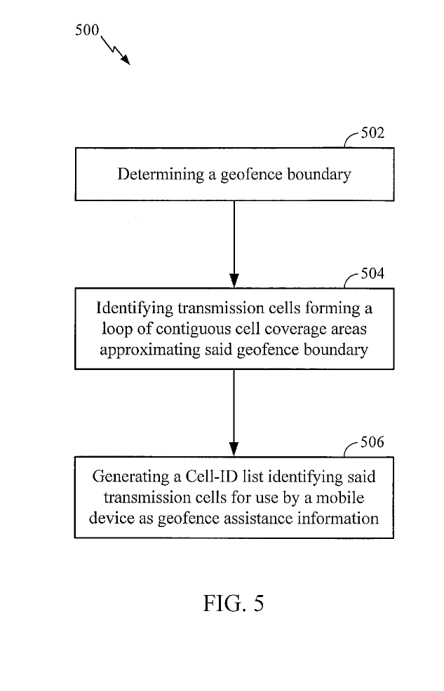

Attention is now drawn to FIG. 5, which is a flow diagram illustrating an implementation of an example process 500 that may be performed, in whole or in part, to facilitate or support one or more operations or techniques for creating geofence assistance information for use in or with a mobile device. It should be appreciated that even though one or more operations are illustrated or described concurrently or with respect to a certain sequence, other sequences or concurrent operations may also be employed. In addition, although the description below references particular aspects or features illustrated in certain other figures, one or more operations may be performed with other aspects or features.

Example process 500 may, for example, begin at operation 502 with determining a geofence boundary, such as using one or more appropriate techniques. For example, a boundary of a geofence of interest may be determined, at least in part, in connection with a suitable location-based service (LBS), just to illustrate one possible implementation. With regard to operation 504, transmission cells forming a loop of contiguous cell coverage areas approximating a geofence boundary of interest may, for example be identified. As previously mentioned, a suitable scan area, such as a scan box enclosing or completely within a geofence boundary, for example, may be formed. Within a scan area, one or more possible loops of contiguous cell coverage areas approximating a geofence boundary may, for example, be determined or identified. In some instances, such as if no loop of contiguous cell coverage areas may be determined or identified, a scan area may, for example, be zoomed in or zoomed out, depending on an implementation, geofence, transmission cells, or the like. As was indicated, a scan area may be zoomed in or zoomed out incrementally, for example, such as until transmission cells forming one or more possible loops of contiguous cell coverage areas approximating a geofence boundary may be identified. If more than one loop may be identified, at times, a loop approximating a perimeter of a geofence boundary of interest may, for example, be selected. At operation 506, a Cell-ID list identifying transmission cells for use by a mobile device as geofence assistance information may, for example, be generated. For example, a Cell-ID list may be generated, at least in part, by adding or including one or more intersecting, overlapping, etc. transmission cells into an initial list of identified boundary cells, as previously mentioned. A Cell-ID list may, for example, comprise, at least in part, geofence assistance information identifying transmission cells associated with a cellular or like wireless communications network of a tracked mobile device and forming a loop of contiguous cell coverage areas approximating a geofence boundary of interest, as was also indicated.

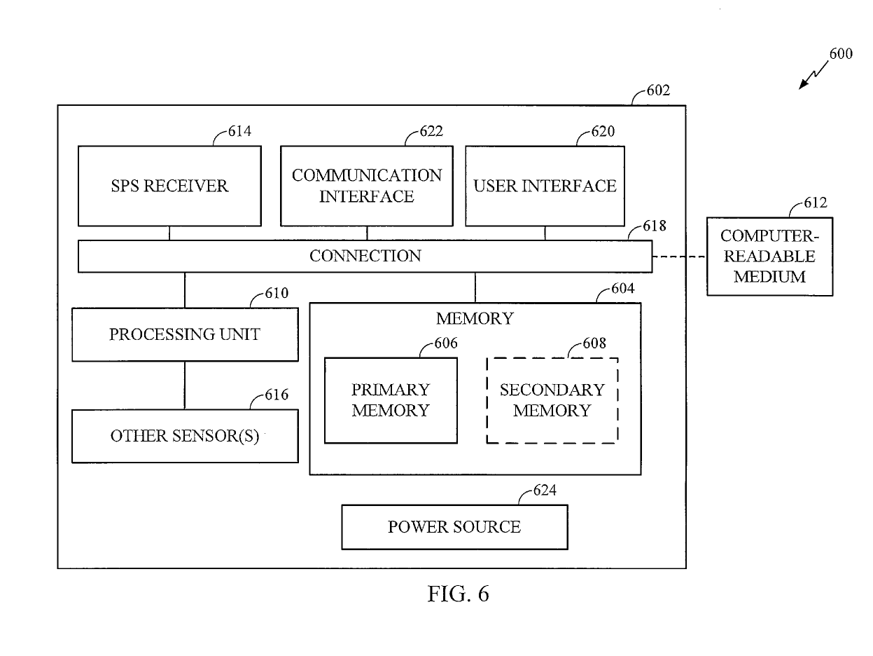

FIG. 6 is a schematic diagram illustrating an implementation of an example computing environment 600 that may include one or more mobile devices capable of partially or substantially implementing or supporting one or more operations or processes for creating geofence assistance information. It should be appreciated that all or part of various devices shown in computing environment 600, processes, or methods, as described herein, may be implemented using various hardware, firmware, or any combination thereof along with software.

Example computing environment 600 may comprise, for example, a mobile device 602 that may include one or more features or aspects of mobile device 102 of FIG. 1, though claimed subject matter is not so limited. For example, mobile device 602 may be capable of communicating with one or more other devices, mobile or otherwise, via a cellular telephone network, the Internet, mobile ad-hoc network, wireless sensor network, or the like. In an implementation, mobile device 602 may be representative of any electronic or computing device, machine, appliance, or platform that may be capable of exchanging information over any suitable network. For example, mobile device 602 may include one or more computing devices or platforms associated with, for example, cellular telephones, satellite telephones, smart telephones, personal digital assistants (PDAs), laptop computers, personal entertainment systems, e-book readers, tablet personal computers (PC), personal audio or video devices, personal navigation devices, or the like. In certain example implementations, mobile device 602 may take the form of one or more integrated circuits, circuit boards, or the like that may be operatively enabled for use in another device. Thus, unless stated otherwise, to simplify discussion, various functionalities, elements, components, etc. are described below with reference to mobile device 602 may also be applicable to other devices not shown so as to support one or more processes associated with example computing environment 600.

Although not shown, optionally or alternatively, there may be additional devices, mobile or otherwise, communicatively coupled to mobile device 602 to facilitate or otherwise support one or more processes associated with computing environment 600, such as discussed above. For example, computing environment 600 may include various computing or communication resources or devices capable of obtaining all or part of position or location information with regard to mobile device 602, applicable geofence, transmission cells, etc. based, at least in part, on one or more wireless signals associated with a positioning system, location-based service, or the like. Location information may, for example, be stored in some manner in memory 604 along with other suitable or desired information, such as one or more parameters for a geofence, transmission cells, cellular or like wireless communications network, or the like.

Memory 604 may represent any suitable information storage medium. For example, memory 604 may include a primary memory 606 and a secondary memory 608. Primary memory 606 may include, for example, a random access memory, read only memory, etc. While illustrated in this example as being separate from a processing unit 610, it should be appreciated that all or part of primary memory 606 may be provided within or otherwise co-located/coupled with processing unit 610. Secondary memory 608 may include, for example, the same or similar type of memory as primary memory or one or more information storage devices or systems, such as, for example, a disk drive, an optical disc drive, a tape drive, a solid state memory drive, etc. In certain implementations, secondary memory 608 may be operatively receptive of, or otherwise enabled to be coupled to, a computer-readable medium 612.

Computer-readable medium 612 may include, for example, any medium that may store or provide access to information, code or instructions (e.g., an article of manufacture, etc.) for one or more devices associated with computing environment 600. For example, computer-readable medium 612 may be provided or accessed by processing unit 610. As such, in certain example implementations, the methods or apparatuses may take the form, in whole or part, of a computer-readable medium that may include computer-implementable instructions stored thereon, which may be executed by at least one processing unit or other like circuitry so as to enable processing unit 610 or the other like circuitry to perform all or portions of a location determination processes, geofence breach detection processes, geofence assistance information creation processes, or any processes to facilitate or support one or more operations or techniques discussed herein. In certain example implementations, processing unit 610 may be capable of performing or supporting other functions, such as geofence implementations, communications, navigations, video or like gaming, or the like.

It should be understood that a storage medium, such as memory 604, computer-readable medium 612, etc. may typically, although not necessarily, be non-transitory or may comprise a non-transitory device. In this context, a non-transitory storage medium may include, for example, a device that is physical or tangible, meaning that the device has a concrete physical form, although the device may change state. For example, one or more electrical binary digital signals representative of information, in whole or in part, in the form of zeros may change a state to represent information, in whole or in part, as binary digital electrical signals in the form of ones, to illustrate one possible implementation. As such, “non-transitory” may refer, for example, to any medium or device remaining tangible despite this change in state.

Processing unit 610 may be implemented in hardware or a combination of hardware and software. Processing unit 610 may be representative of one or more circuits capable of performing at least a portion of information computing technique or process. By way of example but not limitation, processing unit 610 may include one or more processors, controllers, microprocessors, microcontrollers, application specific integrated circuits, digital signal processors, programmable logic devices, field programmable gate arrays, or the like, or any combination thereof.

Mobile device 602 may include various sensors, components, or circuitry, such as, for example, an SPS receiver 614 capable of acquiring wireless signals from a satellite positioning system (SPS), such as the global positioning system (GPS) or other like Global Navigation Satellite System (GNSS), cellular base station, location beacon, or the like. Although not shown, mobile device 602 may include a location-tracking unit that may initiate a position fix of mobile device 602, such as with respect to a geofence boundary of interest, for example, based, at least in part, on one or more received or acquitted wireless signals, such as from an SPS. In some implementations, a location-tracking unit may be at least partially integrated with a suitable processing unit, such as processing unit 610, for example, though claimed subject matter is not so limited. Mobile device 602 may include one or more other sensors 616, such as, for example, an accelerometer, magnetometer, ambient light detector, camera imager, microphone, temperature sensor, atmospheric pressure sensor, etc. to facilitate or otherwise support one or more processes associated with computing environment 600. For example, sensors may provide analog or digital signals to processing unit 610. Although not shown, it should be noted that mobile device 602 may include an analog-to-digital converter (ADC) for digitizing analog signals from one or more sensors. Optionally or alternatively, such sensors may include a designated (e.g., an internal, etc.) ADC(s) to digitize signals, although claimed subject matter is not so limited.

Mobile device 602 may include one or more connections 618 (e.g., buses, lines, conductors, optic fibers, etc.) to operatively couple various circuits together, and a user interface 620 (e.g., display, touch screen, keypad, buttons, knobs, microphone, speaker, trackball, information port, etc.) to receive user input, facilitate or support creating geofence assistance information, provide information to a user, or the like. Mobile device 602 may further include a communication interface 622 (e.g., wireless transmitter or receiver, modem, antenna, etc.) to allow for communication with one or more other devices or systems over one or more suitable communications networks, as was indicated.

In an implementation, mobile device 602 may include a power source 624 to provide power to some or all of the sensors, components, or circuitry. Power source 624 may be a portable power source, such as a battery, for example, or may comprise a fixed power source, such as an outlet (e.g. in a house, electric charging station, car, etc.). It should be appreciated that power source 624 may be integrated into (e.g., built-in, etc.) or otherwise supported by (e.g., stand-alone, etc.) mobile device 602. Although not shown, mobile device 602 may also include a memory or information buffer to collect suitable or desired information, such as, for example, terrestrial or like transmission cell-related information, geofence-related parameters, or the like.

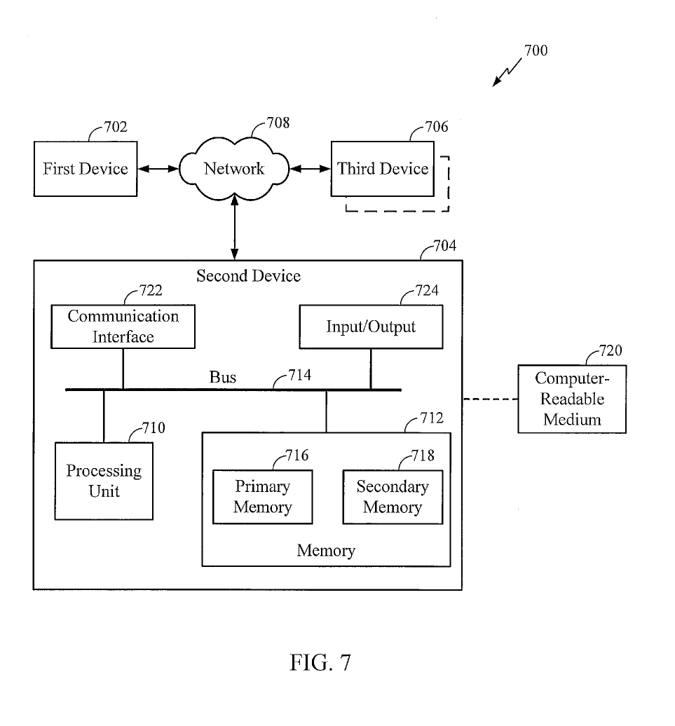

FIG. 7 is a schematic diagram illustrating an implementation of an example computing environment 700 that may include one or more servers or other devices capable of partially or substantially implementing or supporting one or more operations or processes for creating geofence assistance information, such as discussed above in connection with FIG. 1, for example. Computing environment 700 may include, for example, a first device 702, a second device 704, a third device 706, etc., which may be operatively coupled together via a communications network 708.

First device 702, second device 704, or third device 706 may be representative of any device, appliance, platform, or machine that may be capable of exchanging information over communications network 708. By way of example but not limitation, any of first device 702, second device 704, or third device 706 may include: one or more computing devices or platforms, such as, for example, a desktop computer, a laptop computer, a workstation, a server device, or the like; one or more personal computing or communication devices or appliances, such as, for example, a personal digital assistant, mobile communication device, or the like; a computing system or associated service provider capability, such as, for example, a database or information storage service provider/system, a network service provider/system, an Internet or intranet service provider/system, a portal or search engine service provider/system, a wireless communication service provider/system; or any combination thereof. Any of first, second, or third devices 702, 704, and 706, respectively, may comprise one or more of a mobile device, wireless transmitter or receiver, server, etc. in accordance with example implementations described herein.

In an implementation, communications network 708 may be representative of one or more communication links, processes, or resources capable of supporting an exchange of information between at least two of first device 702, second device 704, or third device 706. By way of example but not limitation, communications network 708 may include wireless or wired communication links, telephone or telecommunications systems, information buses or channels, optical fibers, terrestrial or space vehicle resources, local area networks, wide area networks, intranets, the Internet, routers or switches, and the like, or any combination thereof. As illustrated, for example, via a dashed lined box partially obscured by third device 706, there may be additional like devices operatively coupled to communications network 708. It is also recognized that all or part of various devices or networks shown in computing environment 700, or processes or methods, as described herein, may be implemented using or otherwise including hardware, firmware, software, or any combination thereof.

By way of example but not limitation, second device 704 may include at least one processing unit 710 that may be operatively coupled to a memory 712 via a bus 714. Processing unit 710 may be representative of one or more circuits capable of performing at least a portion of a suitable computing procedure or process. For example, processing unit 710 may include one or more processors, controllers, microprocessors, microcontrollers, application specific integrated circuits, digital signal processors, programmable logic devices, field programmable gate arrays, or the like, or any combination thereof. Although not shown, second device 704 may include a location-tracking unit that may initiate a position fix of a tracked mobile device, such as with respect to a geofence boundary of interest, for example, based, at least in part, on one or more received or acquitted wireless signals, such as from an SPS. In some implementations, a location-tracking unit may be at least partially integrated with a suitable processing unit, such as processing unit 710, for example, though claimed subject matter is not so limited.

Memory 712 may be representative of any information storage mechanism or appliance. Memory 712 may include, for example, a primary memory 716 and a secondary memory 718. Primary memory 716 may include, for example, a random access memory, read only memory, etc. While illustrated in this example as being separate from processing unit 710, it should be understood that all or part of primary memory 716 may be provided within or otherwise co-located/coupled with processing unit 710. Secondary memory 718 may include, for example, same or similar type of memory as primary memory or one or more information storage devices or systems, such as, for example, a disk drive, an optical disc drive, a tape drive, a solid state memory drive, etc. In certain implementations, secondary memory 718 may be operatively receptive of, or otherwise configurable to couple to, a computer-readable medium 720. Computer-readable medium 720 may include, for example, any non-transitory storage medium that may carry or make accessible information, code, or instructions for one or more of devices in computing environment 700. Computer-readable medium 720 may also be referred to as a storage medium.

Second device 704 may include, for example, a communication interface 722 that may provide for or otherwise support an operative coupling of second device 704 to at least communications network 708. By way of example but not limitation, communication interface 722 may include a network interface device or card, a modem, a router, a switch, a transceiver, and the like. Second device 704 may also include, for example, an input/output device 724. Input/output device 724 may be representative of one or more devices or features that may be configurable to accept or otherwise introduce human or machine inputs, or one or more devices or features that may be capable or delivering or otherwise providing for human or machine outputs. By way of example but not limitation, input/output device 724 may include an operatively configured display, speaker, keyboard, mouse, trackball, touch screen, information port, or the like.

Methodologies described herein may be implemented by various means depending upon applications according to particular features or examples. For example, such methodologies may be implemented in hardware, firmware, software, discrete/fixed logic circuitry, any combination thereof, and so forth. In a hardware or logic circuitry implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices or units designed to perform the functions described herein, or combinations thereof, just to name a few examples.

For a firmware or software implementation, the methodologies may be implemented with modules (e.g., procedures, functions, etc.) having instructions that perform functions described herein. Any machine readable medium tangibly embodying instructions may be used in implementing methodologies described herein. For example, software codes may be stored in a memory and executed by a processor. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored. In at least some implementations, one or more portions of the herein described storage media may store signals representative of information as expressed by a particular state of the storage media. For example, an electronic signal representative of information may be “stored” in a portion of the storage media (e.g., memory) by affecting or changing the state of such portions of the storage media to represent information as binary information (e.g., via ones and zeros). As such, in a particular implementation, such a change of state of the portion of the storage media to store a signal representative of information constitutes a transformation of storage media to a different state or thing.

As was indicated, in one or more example implementations, the functions described may be implemented in hardware, software, firmware, discrete/fixed logic circuitry, some combination thereof, and so forth. If implemented in software, the functions may be stored on a physical computer-readable medium as one or more instructions or code. Computer-readable media include physical computer storage media. A storage medium may be any available physical medium that may be accessed by a computer. By way of example, and not limitation, such computer-readable media may comprise RAM, ROM, EEPROM, CD-ROM or other optical disc storage, magnetic disk storage or other magnetic storage devices, or any other medium that may be used to store desired program code in the form of instructions or information structures and that may be accessed by a computer or processor thereof. Disk and disc, as used herein, includes compact disc (CD), laser disc, optical disc, digital versatile disc (DVD), floppy disk and blue-ray disc where disks usually reproduce information magnetically, while discs reproduce information optically with lasers.

As discussed above, a mobile device may be capable of communicating with one or more other devices via wireless transmission or receipt of information over various communications networks using one or more wireless communication techniques. Here, for example, wireless communication techniques may be implemented using a wireless wide area network (WWAN), a wireless local area network (WLAN), a wireless personal area network (WPAN), or the like. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rdGeneration Partnership Project” (3GPP). Cdma2000 is described in documents from a consortium named “3rd Generation Partnership Project 2”(3GPP2). 3GPP and 3GPP2 documents are publicly available. A WLAN may include an IEEE 802.11x network, and a WPAN may include a Bluetooth network, an IEEE 802.15x, or some other type of network, for example. The techniques may also be implemented in conjunction with any combination of WWAN, WLAN, or WPAN. Wireless communication networks may include so-called next generation technologies (e.g., “4G”), such as, for example, Long Term Evolution (LTE), Advanced LTE, WiMAX, Ultra Mobile Broadband (UMB), or the like.

In an implementation, a mobile device may, for example, be capable of communicating with one or more femtocells, such as for the purpose of estimating its location, implementing a geofence, communicating with a suitable server, or the like. As used herein, “femtocell” may refer to one or more smaller-size cellular base stations that may be capable of detecting a wireless signal transmitted from a mobile device using one or more appropriate techniques. Typically, although not necessarily, a femtocell may utilize or otherwise be compatible with various types of communication technology such as, for example, Universal Mobile Telecommunications System (UTMS), Long Term Evolution (LTE), Evolution-Data Optimized or Evolution-Data only (EV-DO), GSM, Worldwide Interoperability for Microwave Access (WiMAX), Code division multiple access (CDMA)-2000, or Time Division Synchronous Code Division Multiple Access (TD-SCDMA), to name just a few examples among many possible. In certain implementations, a femtocell may comprise integrated WiFi, for example. However, such details relating to femtocells are merely examples, and claimed subject matter is not so limited.

Also, if applicable, computer-readable code or instructions may be transmitted via signals over physical transmission media from a transmitter to a receiver (e.g., via electrical digital signals). For example, software may be transmitted from a website, server, or other remote source using a coaxial cable, fiber optic cable, twisted pair, digital subscriber line (DSL), or physical components of wireless technologies such as infrared, radio, and microwave. Combinations of the above may also be included within the scope of physical transmission media. Such computer instructions may be transmitted in portions (e.g., first and second portions) at different times (e.g., at first and second times). Some portions of this Detailed Description are presented in terms of algorithms or symbolic representations of operations on binary digital signals stored within a memory of a specific apparatus or special purpose computing device or platform. In the context of this particular Specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

While certain example techniques have been described and shown herein using various methods or systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to particular examples disclosed, but that such claimed subject matter may also include all implementations falling within the scope of the appended claims, and equivalents thereof.

What is claimed is:

1. A method comprising:
determining a geofence boundary; and
identifying transmission cells forming a loop of contiguous cell coverage areas approximating said geofence boundary.

2. The method of claim 1, wherein said loop of contiguous cell coverage areas approximating said geofence boundary comprises a loop of contiguous cell coverage areas approximating a perimeter of said geofence boundary.

3. The method of claim 1, wherein said identifying said transmission cells is based, at least in part, on a maximum antenna range (MAR) obtained with respect to each of said transmission cells.

4. The method of claim 3, wherein said MAR comprises a radius of said each of said transmission cells.

5. The method of claim 1, wherein said transmission cells are identified based, at least in part, on an application of an iterative-type process.

6. The method of claim 1, wherein said identifying said transmission cells further comprises:
forming a scan area enclosing said geofence boundary; and
determining whether a loop of contiguous cell coverage areas surrounding said geofence boundary exists within said scan area.

7. The method of claim 6, and further comprising:
zooming out said scan area in response to a determination that there is no said loop of contiguous cell coverage areas surrounding said geofence boundary exists within said scan area.

8. The method of claim 7, wherein said zooming out comprises incrementally decreasing the magnification of said scan area until said transmission cells forming said loop of contiguous cell coverage areas approximating said geofence boundary are identified within said scan area.

9. The method of claim 1, wherein said identifying said transmission cells further comprises:
forming a scan area completely within said geofence boundary; and
determining whether a loop of contiguous cell coverage areas exists within said scan area.

10. The method of claim 9, and further comprising:
zooming in said scan area in response to a determination that there is no said loop of contiguous cell coverage areas exists within said scan area.

11. The method of claim 10, wherein said zooming in comprises incrementally increasing the magnification of said scan area until said transmission cells forming said loop of contiguous cell coverage areas approximating said geofence boundary are identified within said scan area.

12. The method of claim 9, and further comprising:
zooming out said scan area in response to a determination that there is no said loop of contiguous cell coverage areas exists within said scan area.

13. The method of claim 1, and further comprising:
generating a cell identification (Cell-ID) list identifying said transmission cells for use by a mobile device as geofence assistance information.

14. The method of claim 1, wherein said transmission cells comprise at least one of the following: a base transceiver station; an access point; a femtocell; a wireless transmission node; or any combination thereof.

15. An apparatus comprising:
a communication interface; and
at least one processor programmed with instructions to:
determine a geofence boundary; and
identify transmission cells forming a loop of contiguous cell coverage areas approximating said geofence boundary.

16. The apparatus of claim 15, wherein said loop of contiguous cell coverage areas approximating said geofence boundary comprises a loop of contiguous cell coverage areas approximating a perimeter of said geofence boundary.

17. The apparatus of claim 15, wherein said identifying said transmission cells is based, at least in part, on a MAR obtained with respect to each of said transmission cells via said communication interface.

18. The apparatus of claim 15, wherein said at least one processor programmed with said instructions to said identify said transmission cells further to:
form a scan area enclosing said geofence boundary; and
determine whether a loop of contiguous cell coverage areas surrounding said geofence boundary exists within said scan area.

19. The apparatus of claim 18, wherein said at least one processor further programmed with instructions to zoom out said scan area in response to a determination that there is no said loop of contiguous cell coverage areas surrounding said geofence boundary exists within said scan area.

20. The apparatus of claim 15, wherein said at least one processor programmed with said instructions to said identify said transmission cells further to:
form a scan area completely within said geofence boundary; and
determine whether a loop of contiguous cell coverage areas exists within said scan area.

21. The apparatus of claim 20, wherein said at least one processor further programmed with instructions to zoom in said scan area in response to a determination that there is no said loop of contiguous cell coverage areas exists within said scan area.

22. The apparatus of claim 20, wherein said at least one processor further programmed with instructions to zoom out said scan area in response to a determination that there is no said loop of contiguous cell coverage areas exists within said scan area.

23. The apparatus of claim 15, wherein said at least one processor further programmed with instructions to generate a Cell-ID list identifying said transmission cells for use by a mobile device as geofence assistance information.

24. The apparatus of claim 15, and further comprising:
a satellite positioning system (SPS) receiver to receive one or more wireless signals from at least one wireless communications system; and
a location-tracking unit to initiate a position fix of a mobile device with respect to said geofence boundary based, at least in part, on said one or more received wireless signals.

25. An apparatus comprising:
means for determining a geofence boundary; and
means for identifying transmission cells forming a loop of contiguous cell coverage areas approximating said geofence boundary.

26. The apparatus of claim 25, wherein said loop of contiguous cell coverage areas approximating said geofence boundary comprises a loop of contiguous cell coverage areas approximating a perimeter of said geofence boundary.

27. The apparatus of claim 25, wherein said identifying said transmission cells is based, at least in part, on a MAR obtained with respect to each of said transmission cells.

28. The apparatus of claim 27, wherein said MAR comprises a radius of said each of said transmission cells.

29. The apparatus of claim 25, wherein said transmission cells are identified based, at least in part, on an application of an iterative-type process.

30. The apparatus of claim 25, wherein said means for identifying said transmission cells further comprises:
means for forming a scan area enclosing said geofence boundary; and
means for determining whether a loop of contiguous cell coverage areas surrounding said geofence boundary exists within said scan area.

31. The apparatus of claim 30, and further comprising:
means for zooming out said scan area in response to a determination that there is no said loop of contiguous cell coverage areas surrounding said geofence boundary exists within said scan area.

32. The apparatus of claim 31, wherein said means for zooming out comprises means for incrementally decreasing the magnification of said scan area until said transmission cells forming said loop of contiguous cell coverage areas approximating said geofence boundary are identified within said scan area.

33. The apparatus of claim 25, wherein said means for identifying said transmission cells further comprises:
means for forming a scan area completely within said geofence boundary; and
means for determining whether a loop of contiguous cell coverage areas exists within said scan area.

34. The apparatus of claim 33, and further comprising:
means for zooming in said scan area in response to a determination that there is no said loop of contiguous cell coverage areas exists within said scan area.

35. The apparatus of claim 34, wherein said means for zooming in comprises means for incrementally increasing the magnification of said scan area until said transmission cells forming said loop of contiguous cell coverage areas approximating said geofence boundary are identified within said scan area.

36. The apparatus of claim 33, and further comprising:
means for zooming out said scan area in response to a determination that there is no said loop of contiguous cell coverage areas exists within said scan area.

37. The apparatus of claim 25, and further comprising:
means for generating a Cell-ID list identifying said transmission cells for use by a mobile device as geofence assistance information.

38. An article comprising:
a non-transitory storage medium having instructions stored thereon executable by a special purpose computing platform to:
determine a geofence boundary; and
identify transmission cells forming a loop of contiguous cell coverage areas approximating said geofence boundary.

39. The article of claim 38, wherein said loop of contiguous cell coverage areas approximating said geofence boundary comprises a loop of contiguous cell coverage areas approximating a perimeter of said geofence boundary.

40. The article of claim 38, wherein said storage medium having said instructions to identify said transmission cells further comprises instructions to:
form a scan area enclosing said geofence boundary; and
determine whether a loop of contiguous cell coverage areas surrounding said geofence boundary exists within said scan area.

41. The article of claim 40, wherein said storage medium further comprises instructions to zoom out said scan area in response to a determination that there is no said loop of contiguous cell coverage areas surrounding said geofence boundary exists within said scan area.

42. The article of claim 38, wherein said storage medium having said instructions to identify said transmission cells further comprises instructions to:
form a scan area completely within said geofence boundary; and
determine whether a loop of contiguous cell coverage areas exists within said scan area.

43. The article of claim 42, wherein said storage medium further comprises instructions to zoom in said scan area in response to a determination that there is no said loop of contiguous cell coverage areas exists within said scan area.

44. The article of claim 42, wherein said storage medium further comprises instructions to zoom out said scan area in response to a determination that there is no said loop of contiguous cell coverage areas exists within said scan area.

45. The article of claim 38, wherein said storage medium further comprises instructions to generate a Cell-ID list identifying said transmission cells for use by a mobile device as geofence assistance information.
